(19) United States
(12) Patent Application Publication
(10) Pub. No.: US 2025/0353297 A1
(43) Pub. Date: Nov. 20, 2025

(54) LIQUID EJECTION HEAD AND INKJET PRINTER

(71) Applicant: RISO Technologies Corporation, Tokyo (JP)

(72) Inventor: Jun TAKAMURA, Mishima Shizuoka (JP)

(21) Appl. No.: 19/046,477

(22) Filed: Feb. 5, 2025

(30) Foreign Application Priority Data
May 15, 2024 (JP) 2024-079624

(51) Int. Cl. B41J 2/045; B41J 2/14

(52) U.S. Cl. CPC B41J 2/04588; B41J 2/04573; B41J 2/04581; B41J 2/04596; B41J 2/04598; B41J 2/14233

(57) ABSTRACT

A liquid ejection head includes a nozzle, a pressure chamber that is capable of storing liquid and communicates with the nozzle, a volume of the chamber being variable to eject the liquid from the nozzle, an actuator configured to vary the volume in response to a drive signal, and a drive circuit configured to generate the signal. The chamber has one of states including a steady state in which the volume is unchanged, an expanded state in which the volume is expanded, a first contracted state in which the volume is contracted, and a second contracted state in which the volume is further contracted. The drive signal comprises a first waveform for transitioning from the steady state to the first contracted state, a second waveform for transitioning from the first to second contracted states, and a third waveform for transitioning from the second contracted state to the steady state.

### CROSS-REFERENCE TO RELATED APPLICATION

This application is based upon and claims the benefit of priority from Japanese Patent Application No. 2024-079624, filed on May 15, 2024, the entire contents of which are incorporated herein by reference.

### FIELD

Embodiments described herein relate to a liquid ejection head and an inkjet printer.

### BACKGROUND

A liquid ejection head such as an inkjet head mounted on an inkjet printer is known. The inkjet printer ejects ink droplets from the inkjet head to form an image on a surface of a printing medium. The inkjet head ejects the ink droplets from nozzles communicating with pressure chambers by changing their volumes with piezoelectric actuator elements. An operation of each actuator element is controlled by a drive waveform that is input from a drive circuit.

During the liquid ejection, small droplets referred to as satellite mist different from the ejected droplets for printing may be generated. Since the satellite mist causes deterioration of print quality due to irregular landing, it is desirable to reduce the satellite mist.

### BRIEF DESCRIPTION OF THE DRAWINGS

FIG. 1 is a diagram showing a configuration of a liquid ejection device according to a first embodiment.

FIG. 2 is a perspective view showing a configuration of a liquid ejection head.

FIG. 3 is a cross-sectional view showing a part of the liquid ejection head.

FIG. 4A is a diagram showing drive waveforms and a vibration analysis result according to Comparative Example.

FIG. 4B is a diagram showing drive waveforms and a vibration analysis result according to Example 1.

FIG. 5A is a diagram showing drive waveforms and a vibration analysis result according to Example 2.

FIG. 5B is a diagram showing drive waveforms and a vibration analysis result according to Example 3.

FIG. 6 is a diagram showing drive waveforms and a vibration analysis result according to Example 4.

FIG. 7 is a diagram showing a printing operation of the liquid ejection head.

FIG. 8 is a diagram showing landing accuracy due to the liquid ejection head.

FIG. 9A is a diagram showing printing characteristics according to Comparative Example 1.

FIG. 9B is a diagram showing printing characteristics according to Example 1.

FIG. 9C is a diagram showing printing characteristics according to Comparative Example 3.

### DETAILED DESCRIPTION

In general, according to one embodiment, a liquid ejection head and an inkjet printer capable of reducing satellite mist during liquid ejection is provided.

A liquid ejection head according to one embodiment includes a nozzle, a pressure chamber that is capable of storing liquid and communicates with the nozzle, a volume of the pressure chamber being variable to eject the liquid from the nozzle, an actuator configured to vary the volume of the pressure chamber in response to a drive signal, and a drive circuit configured to generate the drive signal. The pressure chamber has one of states including: a steady state in which the volume is unchanged, an expanded state in which the volume is expanded, a first contracted state in which the volume is contracted, and a second contracted state in which the volume is contracted further from the first contracted state. The drive signal comprises: a first waveform that causes the pressure chamber to transition from the steady state to the expanded state, and then transition from the expanded state to the first contracted state, a second waveform that is subsequent to the first waveform and causes the pressure chamber to transition from the first contracted state to the second contracted state at or after a first timing at which a flow rate of the liquid in the pressure chamber becomes zero, and a third waveform that is subsequent to the second waveform and causes the pressure chamber to transition from the second contracted state to the steady state after a second timing at which the flow rate first becomes zero. The first timing is reached when at least 1.5 AL has elapsed after a beginning of the first waveform, where AL is a half of a natural vibration period of the liquid in the pressure chamber.

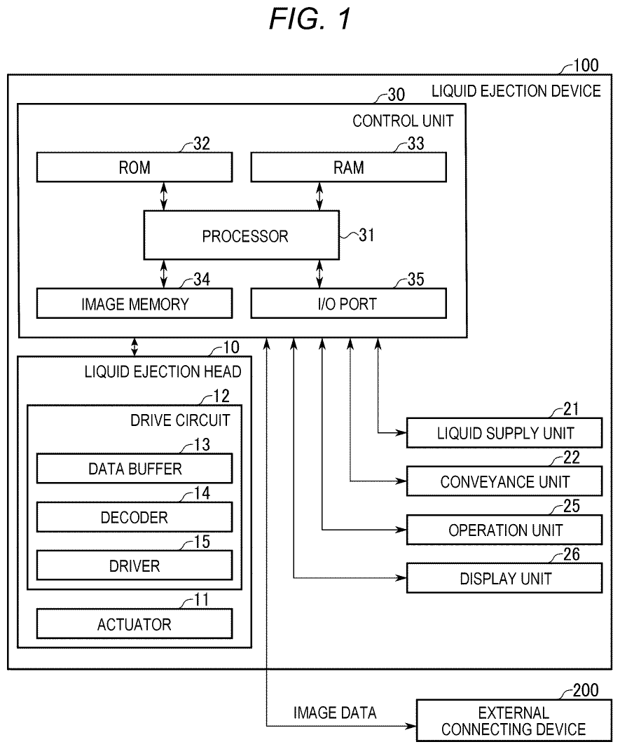

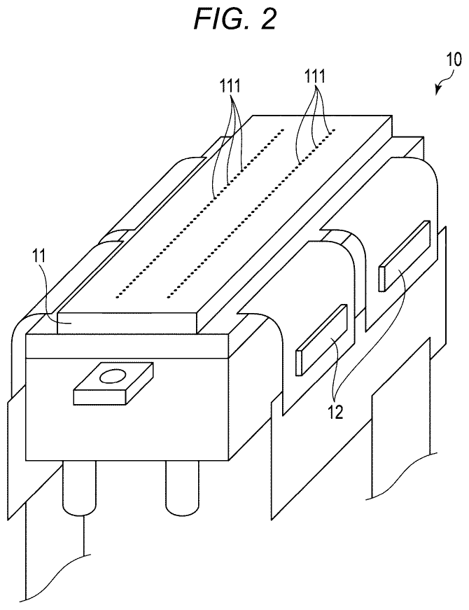

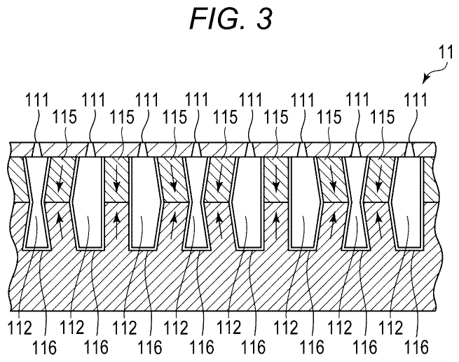

A liquid ejection head 10 and a liquid ejection device 100 according to a first embodiment will be described below with reference to FIGS. 1 to 9. FIG. 1 is a block diagram showing a configuration of the liquid ejection device 100 according to the first embodiment. FIG. 2 is a perspective view showing a configuration of the liquid ejection head 10, and FIG. 3 is a cross-sectional view showing a configuration of an actuator 11 of the liquid ejection head 10.

As shown in FIG. 1, the liquid ejection device 100 includes the liquid ejection head 10, a liquid supply unit 21, a conveyance unit 22, an operation unit 25, a display unit 26, and a control unit 30.

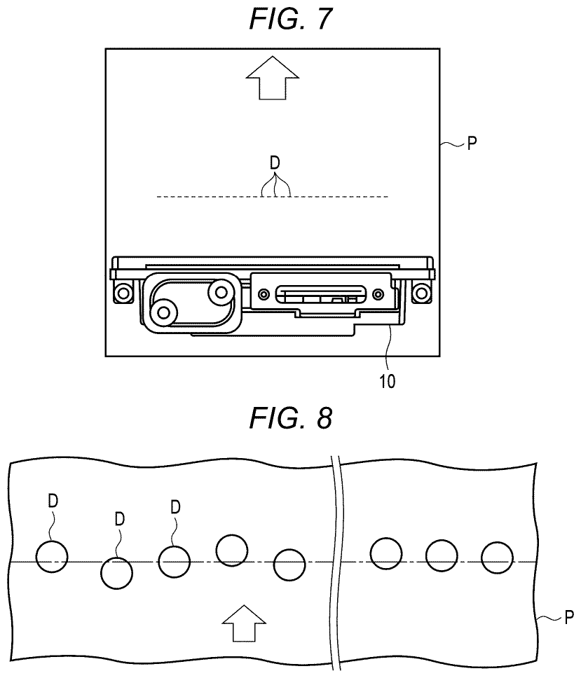

As shown in FIG. 7, the liquid ejection device 100 is an inkjet printer that performs an image forming process on a medium P such as paper by ejecting a liquid such as ink from the liquid ejection head 10 while conveying the medium P such as paper as an ejection target along a predetermined conveyance path passing through a printing position facing the liquid ejection head 10.

The liquid ejection head 10 is, for example, a shear mode shared wall type inkjet head. The liquid ejection head 10 may be a non-circulation type head that does not circulate ink, or may be a circulation type head that circulates ink. In the present embodiment, the liquid ejection head 10 will be described using the example of the non-circulation type head.

For example, the liquid ejection head 10 includes an actuator 11 including a plurality of piezoelectric elements communicating with nozzles, and a drive circuit 12 that drives the actuator 11.

For example, the liquid ejection head 10 includes a plurality of nozzles 111 that ejects a liquid, a plurality of pressure chambers 112 that communicates with the nozzles, and a flow path including a common chamber communicating with the plurality of pressure chambers 112. The flow path of the liquid ejection head 10 is connected to the liquid supply unit 21, and the ink is supplied from the liquid supply unit to the flow path of the liquid ejection head 10.

The actuator 11 is, for example, an actuator plate formed of a piezoelectric member in a plate shape, and includes a plurality of piezoelectric elements 115 and electrodes 116 formed on the piezoelectric elements 115. For example, the groove-shaped pressure chambers 112 are formed between the plurality of piezoelectric elements 115. The actuator 11 applies a voltage to the electrodes 116 of the piezoelectric elements 115 provided corresponding to the pressure chambers 112 to deform the piezoelectric elements 115, such that volumes of the pressure chambers 112 are increased or decreased to eject the ink from the nozzles.

The drive circuit 12 drives the actuator 11 by applying a drive voltage to electrodes of piezoelectric bodies. The drive circuit 12 generates a control signal and a drive signal for operating the piezoelectric elements 115. The drive circuit 12 generates a control signal for controlling a timing of ejecting a liquid and selection of the piezoelectric element 115 to eject a liquid according to an image signal received from the control unit 30 of the liquid ejection device 100. In addition, the drive circuit 12 generates a voltage to be applied to the electrode 116 of the piezoelectric element 115, that is, a drive signal, according to the control signal. If the drive circuit 12 applies a drive signal to the piezoelectric element 115, the piezoelectric element 115 is driven to change the volume of the pressure chamber 112. That is, the actuator 11 can perform drive control under the control of the control unit 30.

As shown in FIG. 1, the drive circuit 12 includes a data buffer 13, a decoder 14, and a driver 15. The data buffer 13 stores printing data in time series for each of the piezoelectric elements of the actuator 11. The decoder 14 controls the driver 15 based on the printing data stored in the data buffer 13 for each of the piezoelectric elements. The driver 15 outputs the drive signal for operating the piezoelectric elements 115 based on the control of the decoder 14. The drive signal is, for example, a voltage signal to be applied to the electrodes 116 of the piezoelectric elements 115.

The liquid supply unit 21 is connected to a primary side of the flow path of the liquid ejection head 10, and supplies the liquid to the flow path of the liquid ejection head 10. For example, the liquid supply unit 21 includes a tank that stores the liquid, a connection flow path that connects the tank and the flow path of the liquid ejection head 10, and a liquid sending pump that sends the liquid in the tank to the liquid ejection head 10.

The conveyance unit 22 conveys a medium such as paper along a predetermined conveyance path and supplies the medium to a printing position. The conveyance unit 22 includes, for example, a plurality of conveyance rollers and conveyance guides disposed along the conveyance path. The conveyance unit 22 supports the medium such that the medium can be moved relative to the liquid ejection head 10.

The operation unit 25 includes function keys such as a power key, a paper feed key, and an error release key.

The display unit 26 includes a display capable of displaying various states of the liquid ejection device 100e.

The control unit 30 is, for example, a control circuit board, and includes a processor 31, a read only memory (ROM) 32, a random access memory (RAM) 33, an image memory 34, and an input/output (I/O) port 35.

The processor 31 is a processing circuit such as a central processing unit (CPU) which is a controller. The processor 31 controls the components of the liquid ejection device 100 to perform various functions for printing according to an operating system and application programs. For example, the processor 31 controls operations of the liquid ejection head 10, the liquid supply unit 21, and the conveyance unit 22 that are provided in the liquid ejection device 100. During printing, the processor 31 transmits the printing data stored in the image memory 34 to the drive circuit 12 in a drawing order.

The ROM 32 stores the above operating system and application programs. The ROM 32 may store data necessary for the processor 31 to execute processing for controlling the units.

The RAM 33 temporarily stores data necessary for the processor 31 to execute processing. The RAM 33 is also used as a work area where information is rewritten by the processor 31. The work area may include an image memory in which the printing data is loaded.

The image memory 34 stores, for example, the printing data received from an external connecting device 200.

The I/O port 35 is an interface unit that receives data from the external connecting device 200 and outputs data to the outside. The printing data from the external connecting device 200 is transmitted to the control unit 30 through the I/O port 35, and is stored in the image memory 34.

In the liquid ejection device 100 having such a configuration, the control unit 30 inputs a signal to the liquid ejection head 10 to apply the drive voltage to the drive circuit 12, generates a voltage potential difference between the plurality of piezoelectric elements 115, selectively deforms the piezoelectric elements 115, and increases or decreases the volumes of the pressure chambers 112, thereby ejecting the liquid from the nozzles 111. For example, when the volume of the pressure chamber 112 is expanded or contracted during driving, a pressure vibration occurs in the pressure chamber 112. Due to the pressure vibration, a pressure inside the pressure chamber 112 increases, and droplets of the liquid (e.g., ink droplets) are ejected from the nozzles 111 communicating with the pressure chamber 112. For example, according to the signal received from the control unit 30, the driver 15 applies the drive voltage to the electrodes of the pressure chambers 112 via the electrodes 116, thereby generating the potential difference between the plurality of piezoelectric elements 115, selectively deforming the piezoelectric elements 115, and changing the volumes of the pressure chambers 112. For example, if the voltage serving as an expansion signal is applied, the piezoelectric element 115 is deformed, the volume of the corresponding pressure chamber 112 increases, the pressure decreases, and the ink in the common chamber flows into the pressure chamber 112. If a drive voltage of a reverse potential is applied to the electrode 116 of the piezoelectric element 115 in a state where the volume of the pressure chamber 112 is increased, the piezoelectric element 115 is deformed to decrease the volume of the pressure chamber 112, and the pressure increases. Therefore, the ink in the pressure chamber 112 is pressurized and ejected from the nozzle 111.

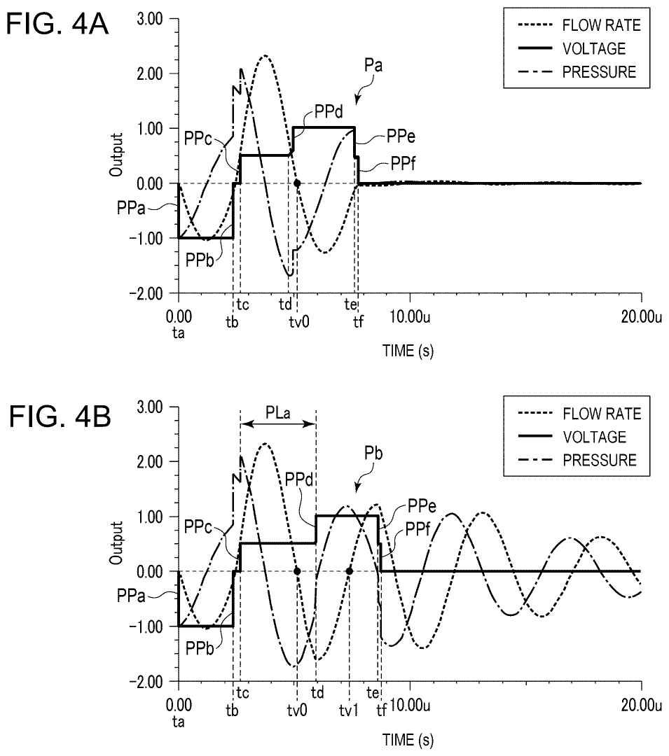

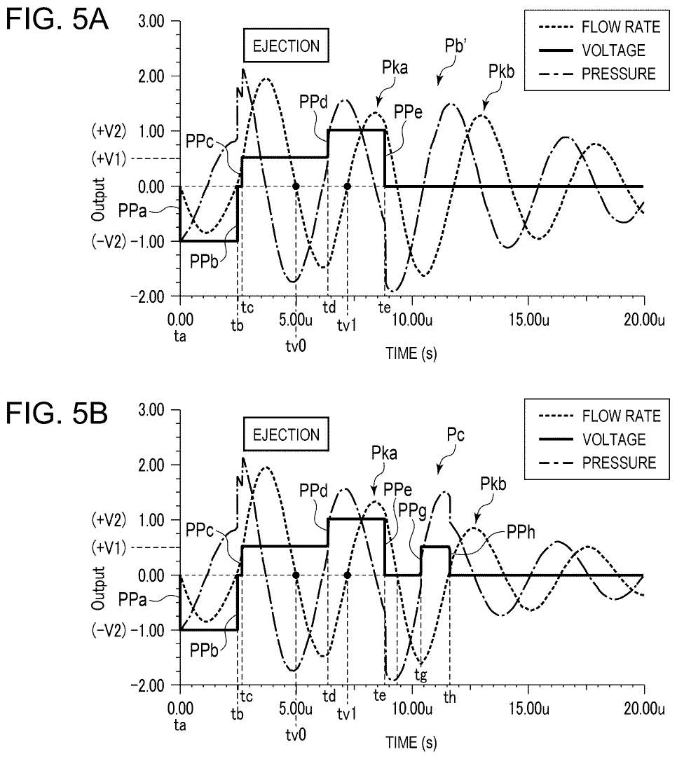

Drive waveforms according to the drive signal generated by the drive circuit 12 of the liquid ejection head 10 will be described with reference to FIGS. 4 and 5.

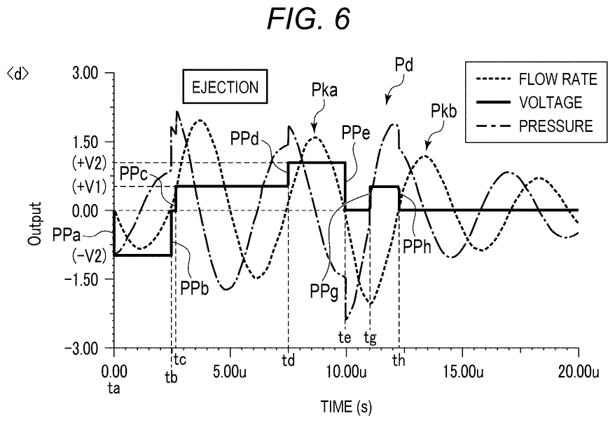

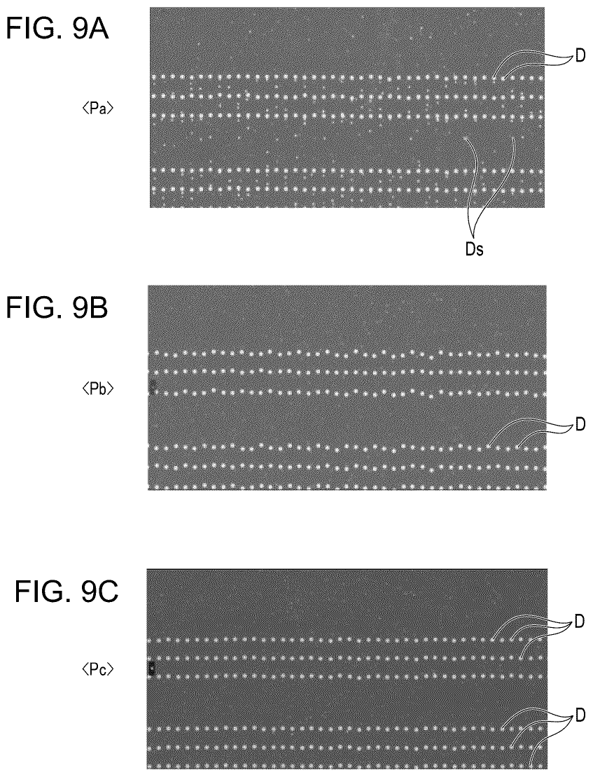

FIGS. 4A and 4B show drive waveforms and vibration analysis results according to Comparative Example 1 and Example 1. FIGS. 5A and 5B show drive waveforms and vibration analysis results according to Example 2 and Example 3. FIG. 6 shows drive waveforms and a vibration analysis result according to Example 4. In the waveform diagrams, a horizontal axis represents a time, and a vertical axis represents a voltage, an ink flow rate, and an ink pressure. In the drawings, the voltage is indicated by a solid line, the flow rate of a nozzle surface is indicated by a broken line, and the pressure of the nozzle is indicated by a one-dot chain line. FIGS. 7 and 8 are diagrams showing a printing operation and landing accuracy by the liquid ejection head. FIGS. 9A-9C are diagrams showing printing characteristics according to Comparative Example 1, Example 1, and Example 3.

FIG. 4A shows an ejection waveform Pa according to Comparative Example 1, and FIG. 4B shows an ejection waveform Pb according to Example 1. Waveform data of the drive waveform is stored in, for example, a memory in the drive circuit 12. An IC of the drive circuit 12 selects which drive waveform to input to the actuator 11 based on gradation data sent from the control board.

The reference ejection waveform Pa according to Comparative Example 1 and the ejection waveform Pb according to Example 1 both have a steady waveform, an expansion waveform for expanding the pressure chamber 112, a first contraction waveform for contracting the pressure chamber 112, and a second contraction waveform for further contracting the pressure chamber 112.

The ejection waveforms Pa and Pb are controlled by switching at least a voltage level of the drive waveform for ejecting the liquid in four stages (−V2, 0, +V1, +V2). Here, voltages are applied in the four stages of a first voltage (0) as an intermediate voltage, a second voltage (−V2) lower than the intermediate voltage, a third voltage (+V1) higher than the intermediate voltage, and a fourth voltage (+V2) higher than the third voltage.

Both the ejection waveforms Pa and Pb are a waveform which brings the pressure chamber into an expanded state from the intermediate voltage, holds the expanded state for an AL time, and then contracts the pressure chamber. The ejection waveforms Pa and Pb are a waveform which contracts the pressure chamber in two stages, holds a first contracted state for a certain time, then holds a second contracted state for a certain time, and thereafter, returns to the initial steady state. In the ejection waveform Pb, satellites are reduced by adjusting the time of the first contracted state and the time of the second contracted state with reference to the ejection waveform Pa.

Here, a voltage condition is V1=½× V2|−V2|=|+V2|. In the reference ejection waveform Pa in a time direction, an expansion time=a first contraction time=a second contraction time=AL (2.50 μs). On the other hand, in the ejection waveform Pb, the expansion time=the second contraction time=AL (2.50 μs). That is, a width of an expansion pulse, a width of a first contraction pulse, and a width of a second contraction pulse of the ejection waveform Pa are a width of an acoustic length (AL). The AL is a half period of a natural vibration period 2 determined by characteristics of the ink and an internal structure of the head.

On the other hand, in the ejection waveform Pb, both the width of the expansion pulse and the width of the second contraction pulse are the width of the acoustic length (AL). The width of the first contraction pulse is 1.5 AL or more. In the ejection waveform Pb, a timing of switching the voltage in order to bring the pressure chamber 112 into the second contracted state is 1.5 AL or more after a timing of bringing the pressure chamber 112 into the first contracted state.

For example, from the steady state, at a predetermined timing ta, the voltage is lowered from the first voltage (0) as the intermediate voltage to the second voltage (−V2) lower than the intermediate voltage (0 V) as an expansion waveform PPa, and the second voltage is continued for a predetermined time. Then, at a timing tb after the first voltage is continued for a predetermined time, the voltage is returned to the first voltage (0) (PPb). Further, at a timing tc after the first voltage is continued for a predetermined time, the third voltage higher than the first voltage is applied and continued for a predetermined time as a first contraction waveform PPc. Then, at a timing td at which the predetermined time is continued, the fourth voltage higher than the third voltage is applied for a predetermined time as a second contraction waveform PPd. After that, at a timing the at which the predetermined time is continued, the voltage is returned to the first voltage stepwise as third waveforms PPe and PPf. In the third waveforms, the voltage is switched stepwise, and the voltage is lowered from the fourth voltage to the third voltage once and then to the first voltage. The ejection waveform Pb is a waveform that performs ejection in an expansion waveform and prevents a vibration in a contraction waveform. The intermediate voltage is, for example, 0 V, and is also referred to as a reference voltage.

In the ejection waveform Pa according to Comparative Example 1, the pressure chamber 112 is expanded by applying the first voltage (0) to the actuator for the AL time as the expansion waveform. Then, if a switch is made such that the third voltage (+V1) is applied to the actuator after the AL time elapses, the pressure chamber 112 shifts from expansion to the first contracted state, the pressure of the nozzle surface reaches a peak, and the ejection starts (i.e., the flow rate of the nozzle surface increases). The first contraction time is held equal to or longer than a time at which the flow rate of the nozzle surface first becomes 0 after the start of the ejection, and after a point tv0 at which the flow rate becomes 0, the pressure chamber 112 shifts from the first contracted state to the second contracted state (i.e., +V2 is applied). By shifting to the second contracted state, an absolute value of the flow rate of the nozzle surface is reduced. The ejection waveform Pa can further reduce the flow rate and the vibration of the pressure by returning the pressure chamber 112 from the second contracted state into the initial flat state at a point at which the flow rate becomes 0 after the second contraction.

In the ejection waveform Pb according to Example 1, by making the timing of returning the pressure chamber 112 from the second contracted state into the initial state be later than that in the ejection waveform Pa according to Comparative Example 1, and by shifting the timing to a point after the point at which the flow rate becomes zero for the second time, the flow rate changes in a positive direction and an ink liquid column is pushed out. By returning the pressure chamber from the second contracted state to the initial state after pushing out the ink column for a predetermined time, an occurrence of satellite drops can be prevented.

As a method of shifting the timing of returning the pressure chamber 112 from the second contracted state to the initial state to be later than a point tv1 at which the flow rate is 0 for the second time, a method of extending the second contraction time and a method of extending the first contraction time are conceivable. In the method of extending the first contraction time, a value of the flow rate after ejection becomes larger. Therefore, in the ejection waveform Pb according to Example 1, after the volume of the pressure chamber 112 is expanded, a waveform that brings the pressure chamber 112 into the first contracted state is applied, and then a waveform that brings the pressure chamber 112 into the second contracted state is applied after the point tv0 at which the flow rate of the pressure chamber 112 first becomes zero.

A timing of applying the fourth voltage (+V2) for bringing the pressure chamber 112 into the second contracted state is after the point tv1 at which the flow rate becomes zero. For example, the timing td at which the voltage is switched in order to bring the pressure chamber 112 into the second contracted state is 1.5 AL or more after the timing of bringing the pressure chamber 112 into the first contracted state.

In other words, the ejection waveform Pb has a first waveform that brings the pressure chamber 112 into the first contracted state after expanding the volume of the pressure chamber 112, a second waveform that changes the pressure chamber 112 into the second contracted state at a timing after a point at which the flow rate of the pressure chamber first becomes 0 after applying the first waveform, and a third waveform that changes the pressure chamber 112 from the second contracted state into the steady state after a point at which the flow rate is 0 for the second time after applying the second waveform.

When the timing of returning the pressure chamber 112 from the second contracted state to the initial state is shifted to a rear of the point tv1 at which the flow rate is 0 for the second time, if the timing is delayed by 0.5 times or more of AL in relation to a time condition, a first flow rate vibration peak Pka after ejection becomes large, and it is possible to further reduce satellites, while a second flow rate vibration peak Pkb after ejection also becomes large, and there is a possibility that erroneous ejection occurs or the vibration affects the next ejection and disrupts the landing accuracy.

FIG. 5A is a diagram showing drive waveforms Pb′ and a vibration analysis result according to Example 2, and FIG. 5B is a diagram showing drive waveforms Pc and a vibration analysis result according to Example 3. Example 2 is obtained by replacing the waveforms PPe and PPf that return stepwise from the fourth voltage to the first voltage of the ejection waveform Pb according to Example 1 with a return waveform PPe that directly returns from the fourth voltage to the first voltage. The rest is the same as in Example 1. Example 3 has a fourth waveform that returns the pressure chamber 112 into the steady state after bringing the pressure chamber 112 into the contracted state again after applying the third waveform according to Example 2. That is, in Example 3, in order to prevent the flow rate vibration, in addition to the waveform according to Example 2, fourth waveforms PPg and PPh for contracting and returning the pressure chamber 112 are disposed at a timing between the first flow rate vibration peak Pka (hereinafter also referred to as the first peak) and the second flow rate vibration peak Pkb (hereinafter also referred to as the second peak) of the flow rate vibration after the return waveform PPe.

The ejection waveform Pc according to Example 3 has the steady waveform, the expansion waveform for expanding the pressure chamber 112, the first contraction waveform for contracting the pressure chamber 112, the second contraction waveform for further contracting the pressure chamber 112, and a third contraction waveform for further contracting the pressure chamber 112 after returning the pressure chamber 112 into the steady state. The ejection waveform Pc is controlled by switching at least a voltage level of the drive waveform for ejecting the liquid in four stages (−V2, 0, +V1, +V2). Here, voltages are applied in the four stages of the first voltage as the intermediate voltage, the second voltage lower than the intermediate voltage, the third voltage higher than the intermediate voltage, and the fourth voltage higher than the third voltage.

Similarly to Pa and Pb, the ejection waveform Pc is a waveform in which the pressure chamber is expanded from 0 level, the expanded state is held for the AL time, and then the pressure chamber is contracted. In the ejection waveform Pc, for example, the contraction waveform has two stages, and is a waveform in which the first contracted state is held for a certain time, the second contracted state is held for a certain time, and then the level is returned to the initial 0 level. Further, the ejection waveform Pc has the fourth waveform for contracting the pressure chamber again between the flow rate vibration peaks after returning the pressure chamber 112 from the second contracted state to the 0 level. That is, the ejection waveform Pc can prevent the flow rate vibration by further adding the contraction waveform to the ejection waveforms Pb and Pb′.

Here, conditions of the voltage of the ejection waveform Pc and conditions in a time direction are the same as those of Pb and Pb′.

In the ejection waveform Pc, the width of the expansion pulse and the width of the second contraction pulse are the width of the acoustic length (AL). The width of the first contraction pulse is 1.5 AL or more.

In other words, the ejection waveform Pc has the first waveform that brings the pressure chamber into the first contracted state after expanding the volume of the pressure chamber, the second waveform that changes the pressure chamber into the second contracted state at the timing after the point at which the flow rate of the pressure chamber first becomes 0 after applying the first waveform, the third waveform that changes the pressure chamber from the second contracted state into the steady state after the point at which the flow rate becomes 0 for the second time after applying the second waveform, and the fourth waveform that returns the pressure chamber into the steady state after bringing the pressure chamber into the contracted state again after applying the third waveform. The rest is the same as in the ejection waveform Pb according to Example 1 described above.

FIG. 6 shows a drive waveform and vibration analysis results when the timing td of bringing the pressure chamber 112 into the second contracted state is set to be 2 AL after the timing of bringing the pressure chamber 112 into the first contracted state according to Example 4. In FIG. 6, a horizontal axis represents a time, and a vertical axis represents a voltage, an ink flow rate, and an ink pressure. In the drawings, the voltage is indicated by a solid line, the flow rate of the nozzle surface is indicated by a broken line, and the pressure of the nozzle is indicated by a one-dot chain line. As shown in FIG. 6, if the timing td of bringing the pressure chamber 112 into the second contracted state is 2 AL after the timing of bringing the pressure chamber 112 into the first contracted state, the first peak Pka can be increased as compared with the case where the timing td is 1.5 AL after the timing of bringing the pressure chamber into the first contracted state according to Example 3 shown in FIG. 5. Accordingly, depending on physical properties of the ink, the width of the first contraction pulse is preferably 2.0 AL or less.

That is, in the present Example, it is preferable that the timing td at which the voltage is switched in order to bring the pressure chamber 112 into the second contracted state is adjusted at a timing in a range of 1.5 AL or more and less than 2.0 AL after the timing of bringing the pressure chamber 112 into the first contracted state.

FIG. 7 is a diagram showing the liquid ejection head 10 and the medium P in the printing operation of the liquid ejection device 100. As shown in FIG. 7, in the liquid ejection device 100, when a liquid is ejected while the liquid ejection head 10 is moved relative to the medium P along a conveyance direction indicated by an arrow, dots D which are a plurality of droplets are formed on the medium P as shown in FIG. 7. In the waveform according to Example 3, the landing accuracy was improved as compared with Example 1.

FIGS. 9A-9C are diagrams showing printing states according to the ejection waveform Pa in Comparative Example 1, the ejection waveform Pb in Example 1, and the ejection waveform Pc in Example 3. According to FIGS. 9A-9C, in the ejection waveform Pa according to Comparative Example 1, satellite mist which is fine droplets is formed around the dots D, and it can be seen that the satellite mist can be reduced in the printing state of the ejection waveform Pb according to Example 1. In addition, as shown in FIGS. 9A-9C, it can be seen that the ejection waveform Pc according to Example 3 has less irregular landing and reduced satellite mist by varying the drive voltage as compared with the ejection waveform Pb according to Example 1. In Comparative Example 1, it can be seen that satellite mists Ds are generated although the landing accuracy is good. In Example 1, the satellite mist is reduced. On the other hand, it can be seen that as compared with Example 1, Example 3 has more uniform landing positions, and has better landing accuracy.

According to the liquid ejection head 10 and the liquid ejection device 100, for example, the satellite mist can be reduced by delaying a time from the first contraction to the second contraction.

Further, the ejection waveform Pc according to Example 3 has a waveform in which the pressure chamber is contracted again at a timing between the flow rate vibration peaks after returning the pressure chamber 112 from the second contracted state into the steady state, thereby improving the landing accuracy. Therefore, for example, as shown in FIGS. 9A-9C, it is possible to obtain a print result with the less satellite mists Ds, and it is possible to reduce variations in the landing positions. Therefore, it is possible to achieve both the landing accuracy and the reduction of the satellite mist.

Embodiments according to the disclosure are not limited to the above-described configuration.

For example, although the above examples have been described using a one-drop ejection waveform, a multi-drop ejection waveform may be used. For example, the ejection waveforms Pb, Pc, Pd and the like according to the above examples may be applied to any one of the ejection waveforms of drops.

A voltage value applied to each piezoelectric element 115 can be appropriately adjusted according to various conditions. For example, a potential difference may be generated by grounding one of the adjacent piezoelectric elements 115 and applying a voltage to the other piezoelectric element 115, or a potential difference may be generated by applying voltages to both of the adjacent piezoelectric elements 115.

For example, the configuration of the liquid ejection head 10 is not limited to the above example, and may be used in a head of another type. For example, the liquid ejection head may drive a liquid ejection unit by causing vibration of a vibration plate provided between the pressure chamber 112 and the drive element unit by deforming a drive element unit.

Although the AL is used as a reference for the time condition, the AL may be slightly different. For example, the expansion time and the first contraction time may be set in a range of 0.9 AL to 1.1 AL.

Each potential of the drive waveform can be appropriately changed, and a voltage value applied to each piezoelectric element 115 can be appropriately adjusted according to various conditions. For example, a potential difference may be generated by grounding one of the adjacent piezoelectric elements 115 and applying a voltage to the other piezoelectric element 115, or a potential difference may be generated by applying voltages to both of the adjacent piezoelectric elements 115.

The drive waveform is not limited to a pull-shooting waveform, but may be a push-shooting waveform or a push-pull-shooting waveform. For example, the configuration of the liquid ejection head 10 is not limited to the above examples, and may be used in a head of another type. For example, a structure in which the ink is ejected by electrostatically deforming the vibration plate, or a heating element type structure in which the ink is ejected from a nozzle using thermal energy of a heater or the like may be employed. In these cases, the vibration plate or the heater serves as an actuator for applying the pressure vibration to the inside of the pressure chamber 112.

The liquid ejection device 100 is an inkjet printer that forms a two-dimensional image with ink on an image forming medium, which is described as an example, but the disclosure is not limited thereto. For example, the liquid ejection device 100 may be a 3D printer, an industrial manufacturing machine, or a medical machine. The liquid ejection device may be the 3D printer, the industrial manufacturing machine, the medical machine, or the like, and may form a three-dimensional object by ejecting, for example, a material substance or a binder for solidifying the material from an inkjet head.

According to at least one embodiment or example described above, it is possible to achieve both the landing accuracy and the reduction of the satellite mist.

While certain embodiments have been described, these embodiments have been presented by way of examples only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head comprising:
a nozzle;
a pressure chamber that is capable of storing liquid and communicates with the nozzle, a volume of the pressure chamber being variable to eject the liquid from the nozzle;
an actuator configured to vary the volume of the pressure chamber in response to a drive signal; and
a drive circuit configured to generate the drive signal, wherein
the pressure chamber has one of states including:
a steady state in which the volume is unchanged,
an expanded state in which the volume is expanded,
a first contracted state in which the volume is contracted, and
a second contracted state in which the volume is contracted further from the first contracted state,
the drive signal comprises:
a first waveform that causes the pressure chamber to transition from the steady state to the expanded state, and then transition from the expanded state to the first contracted state,
a second waveform that is subsequent to the first waveform and causes the pressure chamber to transition from the first contracted state to the second contracted state at or after a first timing at which a flow rate of the liquid in the pressure chamber becomes zero, and
a third waveform that is subsequent to the second waveform and causes the pressure chamber to transition from the second contracted state to the steady state after a second timing at which the flow rate first becomes zero, and
the first timing is reached when at least 1.5 AL has elapsed after a beginning of the first waveform, where AL is a half of a natural vibration period of the liquid in the pressure chamber.

2. The liquid ejection head according to claim 1, wherein
the third waveform comprises:
a waveform that causes the pressure chamber to transition from the second contracted state to the first contracted state, and
a waveform that causes the pressure chamber to transition from the first contracted state to the steady state.

3. The liquid ejection head according to claim 1, wherein
the drive signal further comprises a fourth waveform that is subsequent to the third waveform and causes the pressure chamber to transition from the steady state to the first contracted state, and then transition from the first contracted state to the steady state.

4. The liquid ejection head according to claim 3, wherein
the fourth waveform is input between a timing at which the flow rate is the greatest and a timing at which the flow rate is the second greatest after the liquid is ejected.

5. The liquid ejection head according to claim 1, wherein
the first timing is reached before 2 AL has elapsed after the beginning of the first waveform.

6. The liquid ejection head according to claim 1, wherein
a duration of the expanded state is 0.9 AL to 1.1 AL.

7. The liquid ejection head according to claim 1, wherein
a duration of the second contracted state is 0.9 AL to 1.1 AL.

8. The liquid ejection head according to claim 7, wherein
the duration of the second contracted state is shorter than a duration of the first contracted state.

9. The liquid ejection head according to claim 7, wherein
the duration of the first contracted state is longer than a duration of the expanded state.

10. The liquid ejection head according to claim 1, wherein
the drive signal is a signal of a voltage applied to the actuator, and
the first waveform includes a first voltage of a first value, which is followed by a second voltage of a second value that is greater than the first value, which is followed by a third voltage of a third value that is greater than the second value.

11. The liquid ejection head according to claim 10, wherein
the second value is zero.

12. The liquid ejection head according to claim 10, wherein
the second waveform includes a fourth voltage of a fourth value that is greater than the third value.

13. The liquid ejection head according to claim 12, wherein
an absolute value of the first value is equal to an absolute value of the fourth value.

14. The liquid ejection head according to claim 12, wherein
the third waveform includes a fifth voltage of a fifth value that is equal to the second value.

15. The liquid ejection head according to claim 14, wherein
the drive signal further comprises a fourth waveform that is subsequent to the third waveform and causes the pressure chamber to transition from the steady state to the first contracted state, and then transition from the first contracted state to the steady state, and
the fourth waveforms applies a sixth voltage of a sixth value that is equal to the third value.

16. An inkjet printer comprising:
a plurality of rollers for conveying a print medium; and
an inkjet head configured to eject ink onto the conveyed medium and including:
a nozzle,
a pressure chamber that is capable of storing the ink and communicates with the nozzle, a volume of the pressure chamber being variable to eject the ink from the nozzle,
an actuator configured to vary the volume of the pressure chamber in response to a drive signal, and
a drive circuit configured to generate the drive signal, wherein
the pressure chamber has one of states including:
a steady state in which the volume is unchanged,
an expanded state in which the volume is expanded,
a first contracted state in which the volume is contracted, and
a second contracted state in which the volume is contracted further from the first contracted state,
the drive signal comprises:
a first waveform that causes the pressure chamber to transition from the steady state to the expanded state, and then transition from the expanded state to the first contracted state,
a second waveform that is subsequent to the first waveform and causes the pressure chamber to transition from the first contracted state to the second contracted state at or after a first timing at which a flow rate of the ink in the pressure chamber becomes zero, and
a third waveform that is subsequent to the second waveform and causes the pressure chamber to transition from the second contracted state to the steady state after a second timing at which the flow rate first becomes zero, and
the first timing is reached when at least 1.5 AL has elapsed after a beginning of the first waveform, where AL is a half of a natural vibration period of the ink in the pressure chamber.

17. The inkjet printer according to claim 16, wherein
the third waveform comprises:
a waveform that causes the pressure chamber to transition from the second contracted state to the first contracted state, and
a waveform that causes the pressure chamber to transition from the first contracted state to the steady state.

18. The inkjet printer according to claim 16, wherein
the drive signal further comprises a fourth waveform that is subsequent to the third waveform and causes the pressure chamber to transition from the steady state to the first contracted state, and then transition from the first contracted state to the steady state.

19. The inkjet printer according to claim 18, wherein
the fourth waveform is input between a timing at which the flow rate is the greatest and a timing at which the flow rate is the second greatest after the ink is ejected.

20. The inkjet printer according to claim 16, wherein
the first timing is reached before 2 AL has elapsed after the beginning of the first waveform.
